(19) United States
(12) Patent Application Publication
(10) Pub. No.: US 2015/0092519 A1
(43) Pub. Date: Apr. 2, 2015

(54) Sphere-Inscribed Wheel-Driven Mobile Platform for Universal Orientation

(71) Applicants: National Sun Yat-sen University, Kaohsiung City (TW); DWTEK Co., Ltd., Taichung City (TW)

(72) Inventors: Chau-Chang Wang, Kaohsiung City (TW); Hsin-Hung Chen, Kaohsiung City (TW); Nai-Jen Chang, Taichung City (TW)

(21) Appl. No.: 14/325,713

(22) Filed: Jul. 8, 2014

(30) Foreign Application Priority Data
Sep. 30, 2013 (TW) 102135343

(51) Int. Cl. G01V 1/00

(52) U.S. Cl. CPC G01V 1/001
USPC 367/188

(57) ABSTRACT

A sphere-inscribed wheel-driven mobile platform for universal orientation includes an outer shell unit, a seismometer module, a level sensing module, a movable unit, and a bearing unit. The outer shell unit includes an inner spherical surface defining an accommodating chamber. The seismometer module is disposed in the accommodating chamber, and defines a central axis. The movable unit is mounted to the seismometer module, and includes two rotating wheel units. The bearing unit is mounted to the seismometer module, and includes a plurality of bearing members disposed around the central axis. The seismometer module and the inner spherical surface are spaced by the movable unit and the bearing unit. The seismometer module is rotatable about the central axis and a rotating axis perpendicular to the central axis.

### CROSS-REFERENCE TO RELATED APPLICATION

This application claims priority of Taiwanese Application No. 102135343, filed on Sep. 30, 2013.

### BACKGROUND OF THE INVENTION

1. Field of the Invention

This invention relates to a seismic detector, and more particularly to a sphere-inscribed wheel-driven mobile platform for universal orientation.

2. Description of the Related Art

Taiwanese Invention Patent Application No. 100106142 discloses a leveling system for compact seismic sensors, which includes a transmission having a worm rod and a gear. Such a transmission is bulky, and is difficult to calibrate with respect to verticality. Furthermore, since a plurality of modules of the system are superposed, the lowermost module needs to have a comparatively large rigidity and a high load specification, thereby resulting in the disadvantages of complicated structure and large volume.

### SUMMARY OF THE INVENTION

The object of this invention is to provide a sphere-inscribed wheel-driven mobile platform for universal orientation that has a simple structure and a compact volume.

According to this invention, a sphere-inscribed wheel-driven mobile platform for universal orientation includes an outer shell unit, a seismometer module, a level sensing module, a movable unit, and a bearing unit. The outer shell unit includes an inner spherical surface defining an accommodating chamber. The seismometer module is disposed in the accommodating chamber, and defines an imaginary central axis. The movable unit is mounted to the seismometer module, and includes two rotating wheel units. The bearing unit is mounted to the seismometer module, and includes a plurality of bearing members disposed around the central axis. The seismometer module and the inner spherical surface are spaced by the movable unit and the bearing unit. The seismometer module is rotatable about the central axis and an imaginary rotating axis perpendicular to the central axis.

This invention is advantageous in that, through operation of the movable unit and the bearing unit, the level sensing module and the seismometer module are rotated in the outer shell unit so as to achieve level correction, so that this invention has the advantages of simple structure and compact volume.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of the preferred embodiment of a seismic detector according to this invention;

FIG. 2 is a front view of the preferred embodiment;

FIG. 3 is a schematic perspective view of the preferred embodiment, illustrating an application to ocean bottom earthquake measurement when level correction has not yet performed;

FIG. 4 is a view similar to FIG. 3 but illustrating that a rotating axis is perpendicular to a gravity direction;

FIG. 5 is a view similar to FIG. 3 but illustrating that a horizontal correction has been completed; and

FIG. 6 is a view similar to FIG. 3 but illustrating that the horizontal correction and a directional correction have been completed.

### DETAILED DESCRIPTION OF THE PREFERRED EMBODIMENT

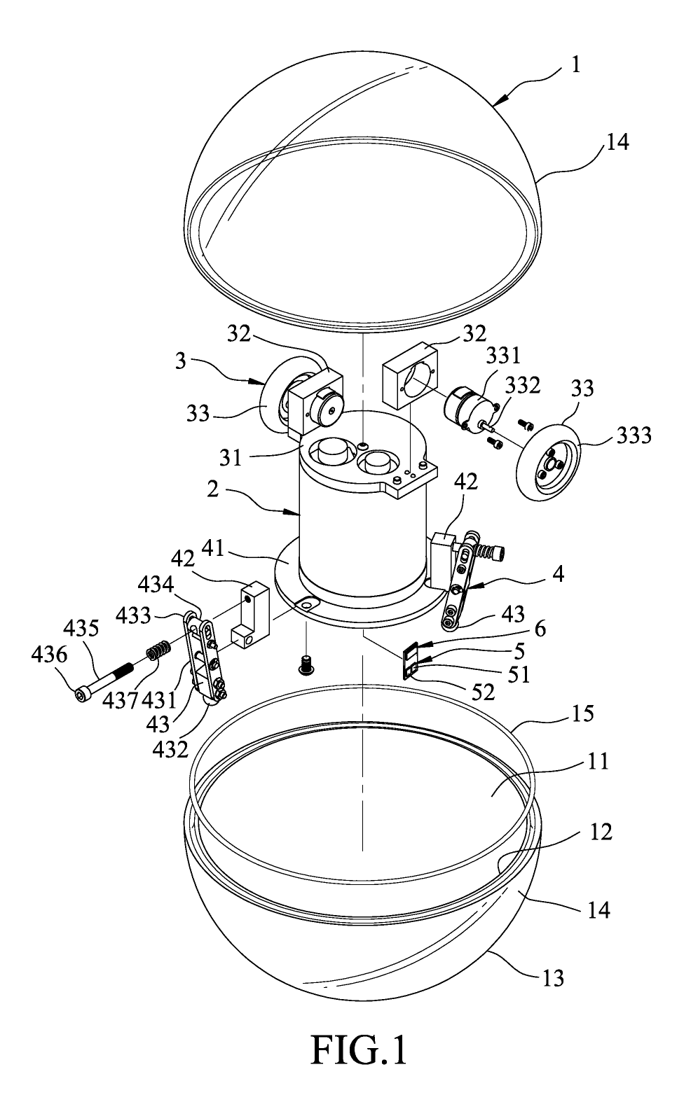

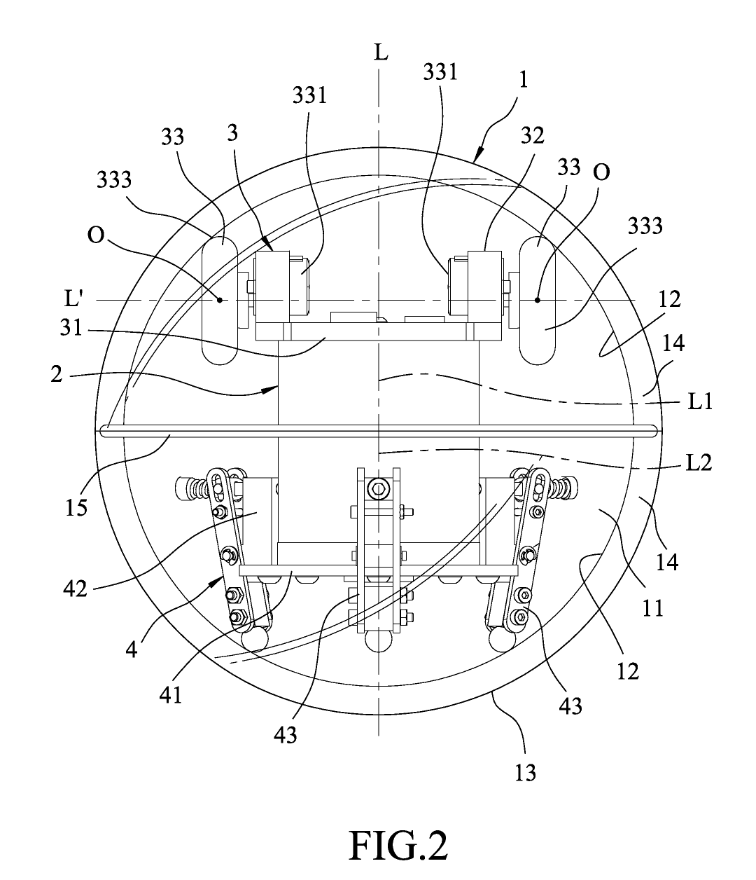

Referring to FIGS. 1 and 2, the preferred embodiment of a sphere-inscribed wheel-driven mobile platform for universal orientation according to this invention includes an outer shell unit 1, a seismometer module 2, a movable unit 3, a bearing unit 4, a level sensing module 5, and an arithmetic processor 6.

The outer shell unit 1 includes an inner spherical surface 12 defining an accommodating chamber 11, and an outer spherical surface 13 spaced apart from the inner spherical surface 12.

In this embodiment, the outer shell unit 1 further includes two interconnected semi-spherical shells 14, and an O-ring 15 disposed between the semi-spherical shells 14 for establishing a water-tight seal between the semi-spherical shells 14.

The seismometer module 2 is disposed in the accommodating chamber 11 in the outer shell unit 1, and defines an imaginary central axis (L). A section of the central axis (L) interconnecting two points of the inner spherical surface 12 has first and second half portions (L1, L2) (see FIG. 2). In this embodiment, the seismometer module 2 is commercially available, for example, Model No. trillium compact 120s, made by nanometrics, which has three-axis seismic sensors.

The movable unit 3 is mounted to the seismometer module 2, is located at the first half portion (L1) of the central axis (L), and includes a first mounting plate 31 connected fixedly to the seismometer module 2, two first supporting frames 32 disposed on the first mounting plate 31 and symmetric with respect to the central axis (L), and two rotating wheel units 33 disposed respectively on the first supporting frames 32.

Each rotating wheel unit 33 includes a motor 331 mounted to the corresponding first supporting frame 32 and having an output shaft 332, and a wheel body 333 connected to the output shaft 332 of the motor 331 and in contact with the inner spherical surface 12 of the outer shell unit 1. The first mounting plate 31 and the first supporting frames 332 may be omitted from the movable unit 3. If this occurs, the motor 331 can be mounted directly on the seismometer module 2.

The output shaft 332 of each motor 331 can be activated to drive forward or reverse rotation of the corresponding wheel body 333. In this embodiment, the motors 331 are stepping motors.

The wheel bodies 333 are symmetric with respect to the central axis (L). The rotating centers (0) of the wheel bodies 333 are located on an imaginary rotating axis (L′) perpendicular to the central axis (L).

In this embodiment, the wheel bodies 333 are parallel to each other, and are perpendicular to the rotating axis (L′). Alternatively, the wheel bodies 333 may not be parallel to each other.

The bearing unit 4 is mounted to the seismometer module 2, and includes a second mounting plate 41 located at the second half portion (L2) of the central axis (L) and connected fixedly to the seismometer module 2, a plurality of second supporting frames 42 disposed around the central axis (L) and disposed on the second mounting plate 41, and a plurality of bearing members 43 disposed respectively on the second supporting frames 42.

In this embodiment, the bearing unit 4 includes three second supporting frames 42 and three bearing members 43.

Each bearing member 43 includes a bearing leg 431, a sliding block 434, an adjustment bolt 435, and a resilient member 437.

Each bearing leg 431 is connected pivotally to the corresponding second supporting frame 42, and includes a proximate end provided with a ball 432 in contact with the inner spherical surface 12 of the outer shell unit 1, and a distal end opposite to the proximate end and permitting the corresponding sliding block 434 to move thereon.

The bearing members 431 may be not connected pivotally to the second supporting members 42. For example, the second mounting plate 41 and the second supporting frames 42 are omitted from the bearing unit 4, and the bearing legs 431 are pivoted directly to the seismometer module 2.

Each adjustment bolt 435 extends through the corresponding sliding block 434, is threaded to the second corresponding supporting frame 42, and has a head 436.

Each resilient member 437 is sleeved on the corresponding adjustment bolt 435, and is disposed between and abuts against the head 43 of the corresponding adjustment bolt 435 and the corresponding sliding block 434 for providing a resilient pushing force to the distal end 433 of the corresponding bearing leg 431, so as to bias the rotating wheel units 33 of the movable unit 3 to contact the inner spherical surface 12 of the outer shell unit 1.

In this embodiment, the resilient members 437 are compression springs.

Alternatively, the resilient members 437 may be omitted from the bearing unit 4. In this state, the wheel bodies 333 may be made of an elastic material for contact with the inner spherical surface 12. In this manner, contact between the rotating wheel units 33 and the inner spherical surface 12 of the outer shell unit 1 also can be maintained.

The rotating wheel units 33 cooperate with the bearing units 4 to space the seismometer module 2 from the inner spherical surface 12 of the outer shell unit 1.

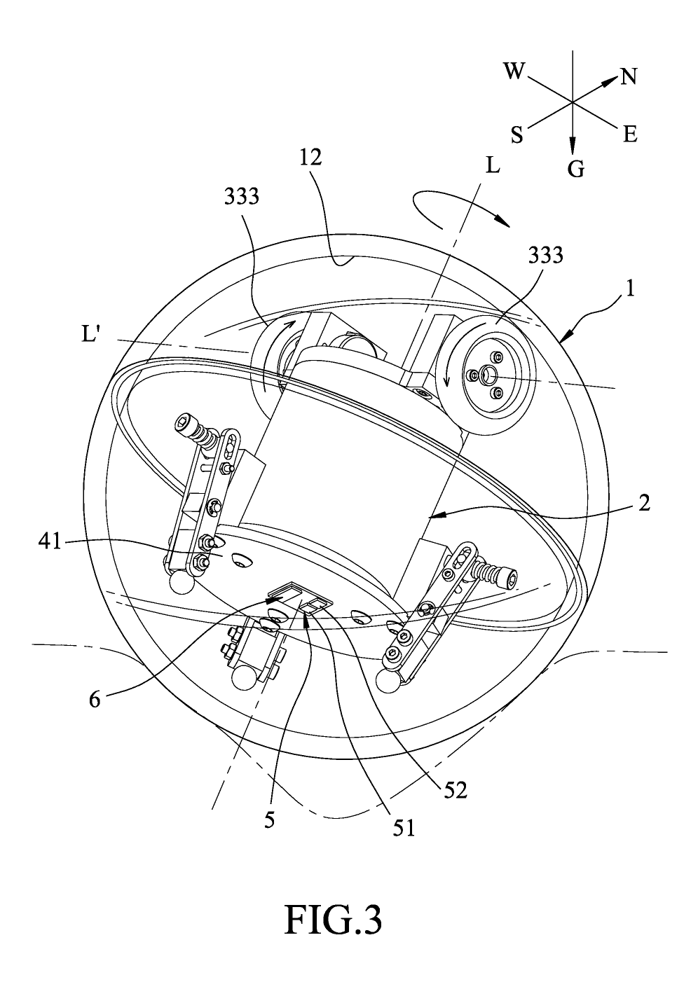

The level sensing module 5 is disposed to the second mounting plate 41, is connected to the seismometer module 2, and includes a gravity sensor 51 for detecting a horizontal deflection amount between the central axis (L) and the water surface, and a vertical deflection amount between the central axis (L) and a gravity direction (G) (see FIGS. 3-6), and a directional sensor 52 for detecting a directional deflection amount between the central axis (L) and the polar direction N-S (see FIGS. 3-6).

In this embodiment, the gravity sensor 51 is commercially available, for example, the model NO. ADXL330, made by Analog Devices, and the directional sensor 52 is also commercially available, for example, the model No. HMC58831, made by Honeywell. Since the gravity sensor 51 and the directional sensor 52 are commercially available, further description thereof will be omitted.

In this embodiment, the gravity sensor 51 and the directional sensor 52 are two separate members. Alternatively, the gravity sensor 51 and the directional sensor 52 may be formed as one piece for detecting the horizontal deflection amount, the vertical deflection amount, and the directional deflection amount.

The arithmetic processor 6 is disposed to the second mounting plate 41, and is electrically connected to the level sensing module 5 and the motors 331 of the movable unit 3. Upon receiving signals from the gravity sensor 51 and the directional sensor 52, the arithmetic processor 6 drives forward or reverse rotation of the motors 331 of the rotating wheel units 33.

The inner spherical surface 12 of the outer shell unit 1 serves as a slideway for the wheel bodies 333 of the rotating wheel units 33. When the wheel bodies 333 rotate in the same direction, the seismometer module 2 rotates about the rotating axis (L′) to change the vertical deflection amount. When the wheel bodies 333 rotate in different directions, the seismometer module 2 rotates about the central axis (L) to change the horizontal deflection amount or the directional deflection amount.

Due to the presence of the water-tight outer shell unit 1, the seismic detector can work fully underwater. It is advantageous that, since the outer surface 13 is spherical, the outer shell unit 1 is subjected to a uniform water pressure.

With particular reference to FIG. 3, when applied to an ocean-bottom earthquake detection, the seismic detector needs to be thrown into the ocean to thereby sink onto the ocean floor. Since the ocean floor is uneven, when the seismic detector reaches the ocean floor, the seismometer module 2 is reclined. For this reason, it is necessary to perform a self-orientating operation prior to detecting, so as to bring the seismometer module 2 into a state shown in FIG. 2. The self-orientating operation will now be described in the following.

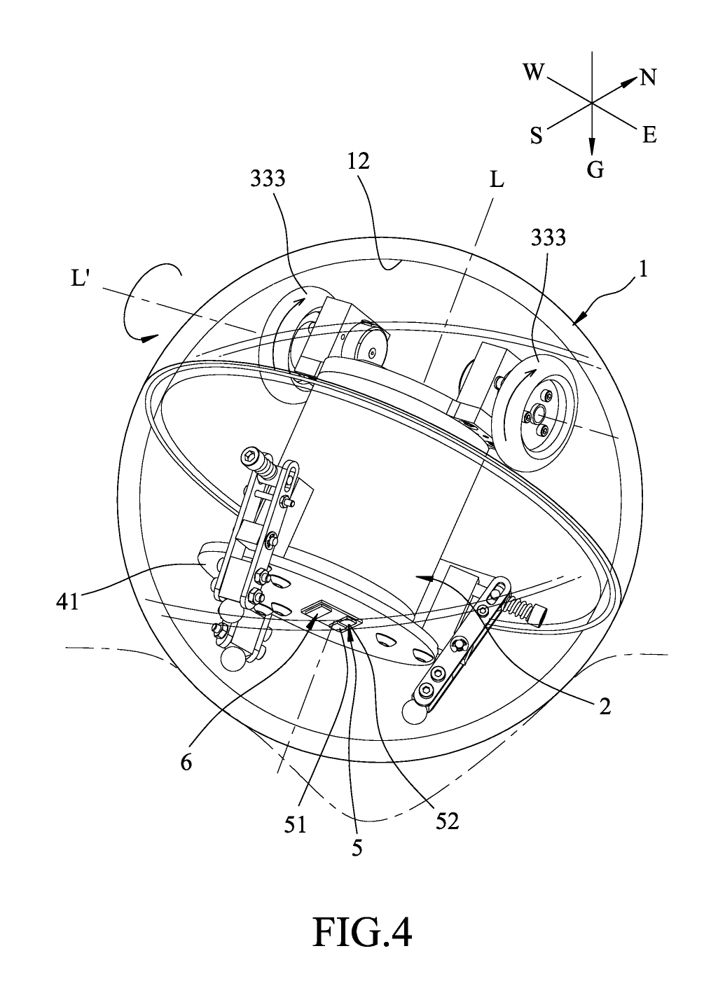

With particular reference to FIGS. 1 and 3, when the horizontal deflection amount between the seismometer module 2 and the water surface is detected by the gravity sensor 51 of the level sensing module 5, the arithmetic processor 6 drives rotation of the motors 331 of the rotating wheel units 33 in different directions. Hence, the wheel bodies 333 are rotated in such a manner to rotate the seismometer module 2 about the central axis (L) until the rotating axis (L′) is perpendicular to the gravity direction (G), as shown in FIG. 4.

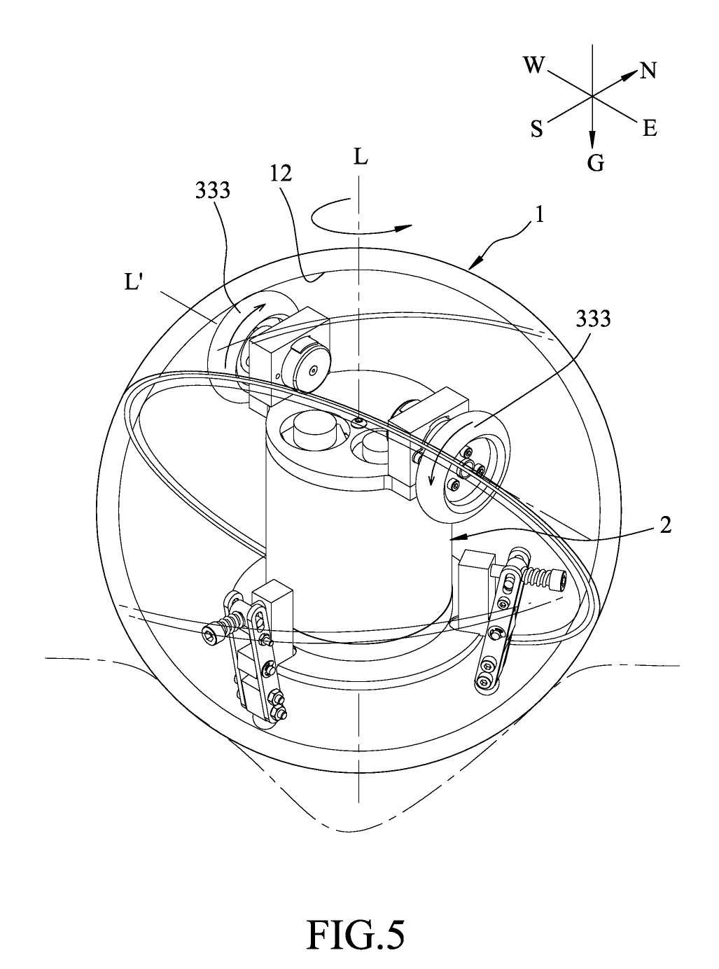

With particular reference to FIGS. 1 and 4, the wheel bodies 333 of the rotating wheel units 33 are rotated in the same direction to drive rotation of the seismometer module 2 about the rotating axis (L′) to thereby change the vertical deflection amount, until the central axis (L) is parallel to the gravity direction (G), as shown in FIG. 5, to thereby achieve a horizontal balance.

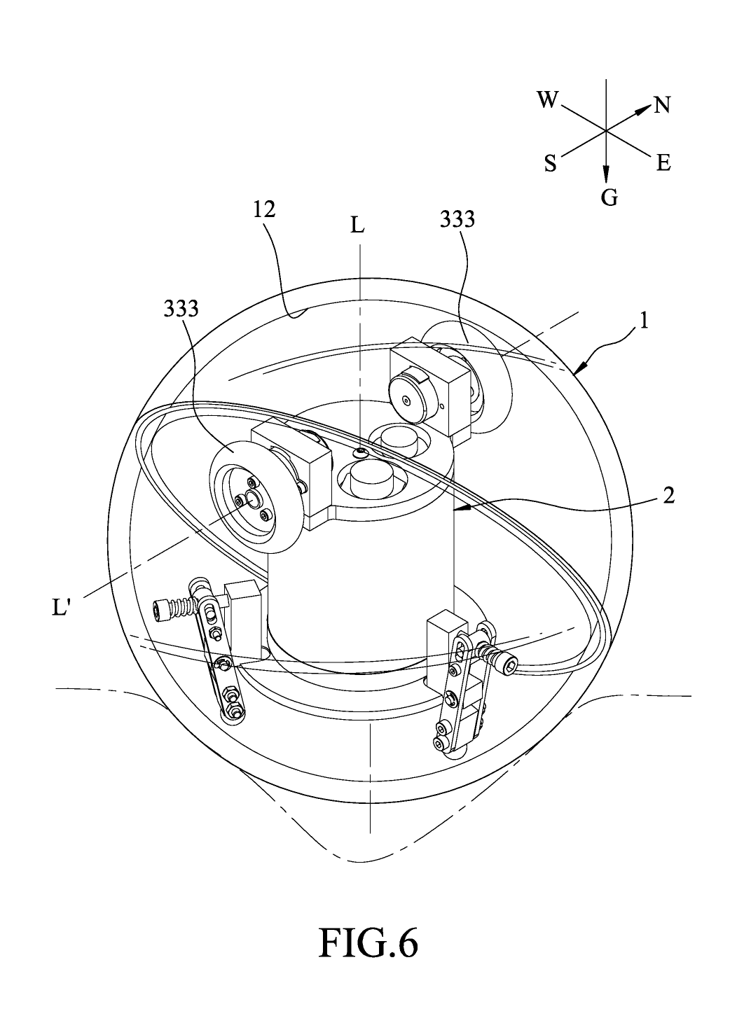

With particular reference to FIGS. 1 and 5, the directional deflection amount between the central axis (L) and the polar direction N-S is detected by the directional sensor 52, the arithmetic processor 6 drives rotation of the motors 331 of the rotating wheel units 33 in different directions to drive rotation of the seismometer module 2 about the central axis (L), until the rotating axis (L′) is parallel to the polar direction N-S, as shown in FIG. 6, to thereby completing the self-orientating operation.

The above examples are not limited to open-loop control. To achieve accurate level correction, the arithmetic process 6 can adopt closed-loop control.

In the above examples, the horizontal deflection amount, the vertical deflection amount, and the directional deflection amount of the seismometer module 2 are adjusted by rotating the wheel bodies 333 at the same speed. Alternatively, the horizontal deflection amount, the vertical deflection amount, and the directional deflection amount of the seismometer module 2 may be adjusted by rotating the wheel bodies 333 at different speeds to move quickly the seismometer module 2 from an original position shown in FIG. 3 to a balance position shown in FIG. 6.

In view of the above, an assembly of the movable unit 3, the bearing unit 4, and the level sensing module 5 is compact, and has a simple structure. Thus, the object of this invention is achieved.

With this invention thus explained, it is apparent that numerous modifications and variations can be made without departing from the scope and spirit of this invention. It is therefore intended that this invention be limited only as indicated by the appended claims.

We claim:

1. A sphere-inscribed wheel-driven mobile platform for universal orientation comprising:
an outer shell unit including an inner spherical surface that defines an accommodating chamber;
a seismometer module disposed in said accommodating chamber in said outer shell unit and defining an imaginary central axis having a section interconnecting two points of said spherical surface, said section having two half portions;
a level sensing module connected to said seismometer module and adapted for detecting a horizontal deflection amount between said central axis and a water surface, a vertical deflection amount between said central axis relative and a gravity direction, and a directional deflection amount between said central axis and a polar direction;
a movable unit mounted to said seismometer module and including two rotating wheel units, each of said rotating wheel units including a wheel body in contact with said inner spherical surface of said outer shell unit, and a motor driving forward or reverse rotation of said wheel body, said wheel bodies of said rotating wheel units being symmetric with respect to said central axis, rotating centers of said wheel bodies being located on an imaginary rotating axis perpendicular to said central axis; and
a bearing unit mounted to said seismometer module and including a plurality of bearing members disposed around said central axis and in contact with said inner spherical surface of said outer shell unit;
wherein said rotating wheel units cooperate with said bearing members of said bearing units to space said seismometer module from said inner spherical surface of said outer shell unit;
wherein, when said wheel bodies rotate in the same direction, said seismometer module rotates about said rotating axis to change said vertical deflection amount, and when said wheel bodies rotate in different directions, said seismometer module rotates about said central axis to change said horizontal deflection amount or said directional deflection amount.

2. The sphere-inscribed wheel-driven mobile platform for universal orientation as claimed in claim 1, wherein said outer shell unit further includes an outer spherical surface spaced apart from said inner spherical surface.

3. The sphere-inscribed wheel-driven mobile platform for universal orientation as claimed in claim 2, wherein said outer shell unit further includes two semi-spherical shells that are interconnected in a such a manner that a water-tight seal is established therebetween.

4. The sphere-inscribed wheel-driven mobile platform for universal orientation as claimed in claim 1, wherein said wheel bodies of said rotating wheel units of said movable unit are parallel to each other, and are perpendicular to said rotating axis.

5. The sphere-inscribed wheel-driven mobile platform for universal orientation as claimed in claim 4, wherein said movable unit further includes a first mounting plate connected fixedly to said seismometer module, and two first supporting frames disposed to said first mounting plate and symmetric with respect to said central axis, said motors of said rotating wheel units being mounted respectively to said first supporting frames, said wheel bodies being connected respectively to output shafts of said motors.

6. The sphere-inscribed wheel-driven mobile platform for universal orientation as claimed in claim 1, wherein said bearing members of said bearing units are symmetric with respect to said central axis, each of said bearing members including a bearing leg in contact with said inner spherical surface, and a resilient member biasing said bearing leg to maintain contact between a corresponding one of said rotating wheel units of said movable unit and said inner spherical surface.

7. The sphere-inscribed wheel-driven mobile platform for universal orientation as claimed in claim 6, wherein said movable unit and said bearing unit are located respectively at two half portions of a section of said central axis that interconnects two points of the inner spherical surface, and said bearing unit further includes a second mounting plate spaced apart from said movable unit and connected fixedly to said seismometer module, and a plurality of second supporting frames disposed around said central axis, said bearing legs of said bearing members being connected respectively and pivotally to said second supporting frames, each of said bearing legs having a proximate end provided with a ball body in contact with said inner spherical surface, and a distal end opposite to said proximate end, said resilient members of said bearing members pressing against said distal ends of said bearing legs.

8. The sphere-inscribed wheel-driven mobile platform for universal orientation as claimed in claim 7, wherein each of said bearing members of said bearing unit further includes a sliding block and an adjustment bolt, said sliding blocks of said bearing members being disposed respectively and movably on said distal ends of said bearing legs, said adjustment bolt of each of said bearing members extending through a corresponding one of said sliding blocks and being threaded to a corresponding one of said second supporting frames, said resilient members being disposed between and abutting against said sliding blocks and heads of said adjustment bolts.

9. The sphere-inscribed wheel-driven mobile platform for universal orientation as claimed in claim 7, wherein said level sensing module is disposed to said second mounting plate, is connected to said seismometer module, and includes a gravity sensor for detecting said horizontal deflection amount and said vertical deflection amount, and a directional sensor for detecting said directional deflection amount.

10. The sphere-inscribed wheel-driven mobile platform for universal orientation as claimed in claim 1, further comprising an arithmetic processor electrically connected to said level sensing module and said motors of said movable unit.
